(19) United States
(12) Patent Application Publication
(10) Pub. No.: US 2025/0012230 A1
(43) Pub. Date: Jan. 9, 2025

(54) PISTON, CRANK DRIVE AND RECIPROCATING INTERNAL COMBUSTION ENGINE

(71) Applicants: NEWGREEN AG, Staad (CH); NEWGREEN AMERICAN INC., Pensacola, FL (US)

(72) Inventor: Stephan Geschke, Staad (CH)

(21) Appl. No.: 18/710,350

(22) PCT Filed: Dec. 22, 2022
(86) PCT No.: PCT/EP2022/087653

§ 371 Date: May 15, 2024

(30) Foreign Application Priority Data
Dec. 23, 2021 (DE) 10 2021 134 520.0

(51) Int. Cl. F02F 3/02; F16J 1/16

(52) U.S. Cl. CPC F02F 3/02; F16J 1/16

(57) ABSTRACT

The invention relates to a piston, in particular for an engine, having a top side, a bottom side, a circumferential surface extending along a circumference and a movement axis extending essentially parallel to a tangent of the circumferential surface and through the top side and through the bottom side, the circumferential surface being designed for guiding the piston in a cylinder bore of a cylinder along the movement axis, the top side being designed for absorbing compressive forces of a gas and the bottom side having a connecting rod receptacle, wherein the connecting rod receptacle has one or more undercuts in a traction and a compression direction, so that the connecting rod receptacle is designed to receive a thickened portion of a connecting rod which corresponds to the connecting rod receptacle in a form-fitting manner and can be pivoted about a pivot axis, wherein the piston has any number of radially arranged, essentially flat cross-sectional surfaces extending through the axis of movement. The invention also relates to a crank drive and an internal combustion engine.

### CROSS-REFERENCES TO RELATED APPLICATIONS

This is a U.S. national stage filing based on PCT/EP2022/087653

### STATEMENT REGARDING FEDERALLY SPONSORED RESEARCH OR DEVELOPMENT

Not applicable

### MICROFICHE APPENDIX

Not applicable

### BACKGROUND OF THE INVENTION

The invention relates to a piston, in particular for a prime mover, with an upper side, a lower side, a circumferential surface extending along a circumference and being substantially parallel to the piston's axis movement. The circumferential surface extends from the piston's upper side to the lower side, the circumferential surface being designed to guide the piston in a cylinder bore along the axis of movement and the upper side being designed to receive the pressure forces of a gas. The lower side of the piston has a connecting rod holder, with the connecting rod holder having one or more undercuts. The undercuts are positioned to engage a connecting rod head and prevent the connecting rod head pulling free of the piston when the connecting rod is pulling the piston, so that the connecting rod holder can be used for positively connecting the connecting rod and the piston in a pivotable arrangement about a pivot axis. The piston has any number of substantially flat cross-sectional surfaces extending through the axis of movement and arranged radially, each of which has approximately the same cross-sectional area. The invention also relates to a crank drive with a piston and in particular a connecting rod as well as a reciprocating piston combustion engine.

Previous engines that work according to the reciprocating piston principle, such as diesel engines or petrol engines, and other engines, usually have a piston with a cylindrical perimeter circumferential surface around a central axis aligned with the bore of a cylinder in which the piston reciprocates. The piston is pivotally connected to a connecting rod on a swivel axis. In the prior art designs the piston and connecting rod are pivotably connected to each other with a so-called piston pin. The piston pin adds to the reciprocating mass of the engine, which has a negative effect on the efficiency of the engine and thus also the pollutant emissions of the engine, or stated another way, prevents the reduction of pollutant emissions.

If a piston is equipped with a connecting rod holder arranged on the underside and the connecting rod is equipped with a head that can be attached to the connecting rod holder, this results in a reduction in the reciprocating mass of the assembly (since the piston pin is absent) and a reduction in frictional losses. However, thermal management of such a piston is often difficult, especially in relation to heat produced by the combustion process in the engine. Furthermore, in any case and regardless of the design of the piston, the changing piston geometry caused by thermal expansion must be accommodated. Pistons of course expand when heated. Prior art pistons, especially in diesel engines, must be made with an oval peripheral surface in order to assume a suitable, round geometry in the warm operating state.

The object of the invention is to improve the state of the art.

### BRIEF SUMMARY OF THE PRESENT INVENTION

The problem is solved by a piston, in particular for a prime mover, with an upper side, a lower side and a circumferential surface extending along a circumference. The piston moves along a reciprocating axis of movement extending substantially parallel to a tangent of the circumferential surface. The circumferential surface generally guides the piston along a cylinder bore in which the piston operates. The piston's upper side is designed to absorb compressive forces of a gas and the lower side has a connecting rod receptacle, wherein the connecting rod receptacle is arranged to withstand the forces exerted by an attached connecting rod. An undercut or several undercuts are arranged to that the connecting rod holder receives and retains a connecting rod head in a form-fitting manner and pivotable about a pivot axis, the piston having any desired shape. The piston is shaped so that any number of cross sections taken through the piston's axis of movement have a substantially uniform cross-sectional area. The cross sections taken through this axis of movement desirably vary less than 10% in cross sectional area.

This geometric design of the piston, in particular by means of providing substantially uniform cross-sectional areas for every cross section taken through the axis of movement, results in a uniform thermal expansion behavior around the circumference of the piston, whereby the piston is geometrically adapted very precisely to, for example, the diameter of the cylinder bore in which it operated. This improves both the sealing behavior in relation to a wall of the cylinder and greatly simplifies the production of the piston, since, for example, a uniform circumferential geometry of the piston can be achieved (rather than the oval shape found in the prior art).

The following terms are explained in this context:

A “piston” is a movable component which, together with a surrounding housing, in the case of an engine and related machines comprises a “cylinder.” The volume of the cylinder changes due to a reciprocating movement of the piston in the cylinder. Such a principal can be realized in different ways in different designs, in the case of the present invention, in particular a reciprocating piston that can be moved up and down within a cylinder.

An “upper side” (top side) of such a piston is, for example, the area of the piston known as the piston crown, which in an internal combustion engine, for example, is assigned to the combustion chamber volume. This upper side then, using the example of the internal combustion engine, absorbs the pressure forces from the expanding ignited gas mixture and thus transfers the forces required to operate the crankshaft drive to the connecting rod and from thence to the crankshaft.

An “underside” is the side of the piston facing the connecting rod, i.e. in particular the side of the piston that has the connecting rod holder.

A “circumferential surface” is the surface of the piston which, for example, faces the cylinder bore in the case of an internal combustion engine. The exemplary details given refer to the usual design of a piston having a generally cylindrical shape. Likewise, a correspondingly different shape of piston and a different shape of cylinder bore can also be realized if technically feasible. The circumferential surface can also typically be used as a so-called piston skirt.

An “axis of movement” describes the axis along which the piston moves during a rotation of the crankshaft, for example. In particular, this axis of movement is parallel to a center axis of a cylinder bore, whereby in each case no mathematically exact axis is intended but rather a corresponding direction with reasonable technical deviations is intended.

A “cylinder bore” can, for example, be a cast and/or drilled cavity within an engine block of an internal combustion engine, which is then further refined, for example by honing. However, such a cylinder bore can also be a round or essentially round cavity of a steam engine, a steam generator expansion drive or another form of power engine. The piston closes off the cylinder bore towards a last open side so that pressure forces in the cylinder bore can be transmitted to the piston. Forces then act on the piston inside the cylinder bore.

A “gas” that exerts compressive forces can be a simple compressed gas such as compressed air, or a gas resulting from a phase transition, such as superheated steam, or also a gas mixture of, for example, ambient air and gasoline or diesel or another fuel, which, through ignition, for example in a gasoline or diesel engine, exerts compressive forces on the engine components.

A “connecting rod holder” on the underside of the piston is used to attach a connecting rod to the piston in a tension-proof and pivotable manner, so that the piston together with the connecting rod are linked together in a so-called crank drive, for example in a connecting rod linking a piston to a crankshaft. A pivoting connection of the piston to the connecting rod is established in such a way that the piston is free to pivot with respect to the connecting rod, but it otherwise secured thereto.

An “undercut” refers to such a design of a mount or part of a mount in which a component or an area or partial area in the direction of force positively prevents a pull-out or positively enables a transmission of forces. Such an undercut can be used by a component suspended or attached via the undercut to transmit forces.

A “thickening” (such as a head) of the connecting rod is such an area which has a larger or wider cross-section or has a larger or wider diameter than a part of the connecting rod located adjacent to the thickening. In particular, such a thickening can serve, together with the undercut, in particular with the surfaces formed by the undercut, to create a form-fit tensile or torsional connection to form a force-resistant connection.

A corresponding “cross-sectional area” refers to an essentially flat plane, which results from an imaginary cutting of the piston with a cutting plane that passes through the piston's axis of movement. This cross-sectional area is specified as a measure of area, where a desirable feature of the present invention is that this cross-sectional area is the same or substantially the same with respect to another cross-section rotated at an angle of rotation about the axis of movement.

In order to be able to control the thermal expansions even more precisely, the piston is shaped in such a way that the cross-sectional area of a plurality of planes passing through the axis of movement shall have a variation of preferably less than 7%, more preferably less than 5%, and even more preferably less than 2% from one another.

In this context, it should be noted that a first cross-sectional area and a second cross-sectional area each denote any cross-sectional area, for example in one case two cross-sectional areas in different reference axes, for example perpendicular to the first cross-sectional are identical or similar in design, so that, for example, the thermal deformation behavior of the piston is controlled in the two main directions. The respective cross-sectional areas can also run at any angle to each other, so that in particular a comparison of any cross-sectional areas around a circumference of the piston withstands the substantial uniformity criteria.

In one embodiment, the circumferential surface is provided with a protective cover from the top to the bottom and/or across the bottom the lower side of the piston, whereby the piston skirt has a radial thickness of less than 10%, less than 5% and/or less than 2% of a diameter of the piston.

A “piston skirt”, which is generally a tube-like extension of the piston in the direction of the underside, i.e. in the direction of the crankshaft, is particularly thin walled. Thermal expansion in this area greatly reduced.

In order to achieve a balance with regard to the respective cross-sectional areas compared to, for example, the necessary surface areas and/or necessary parts of the piston, for example parts of the undercut, an equalizing volume and/or several equalizing volumes are arranged on the upper side and/or on the underside, by equalizing volume and/or equalizing volumes.

Consequently, a corresponding compensation volume or corresponding compensation volumes can be applied in such a way that the material of the piston is at one point added or removed, where this is not technically necessary, so that the criteria of the uniformity of different cross-sectional areas in relation to each other are met.

In one embodiment, a removal volume and/or a plurality of removal volumes can be additionally recessed on the upper side and/or on the lower side, whereby a compensation for volume sections of the piston arranged on the respective cross-sectional areas is created by means of the reduced volume or volumes.

This means that, also in combination with corresponding added volumes (compensation volumes), the removal volumes can be used to compensate for corresponding area sizes.

A “compensation volume” describes an increased volume in a particular area, i.e. an additional material applied, whereas a “removal volume” describes a material that is not present or has been removed. For example, when casting a piston an additional tool volume can be provided in the molding tool for the corresponding removal volume, whereby a corresponding volume is removed from the molding tool with respect to a compensation volume. If, other hand, the piston is created by a metal-cutting process, it is possible to produce corresponding compensation volumes of removal volumes in a CNC milling program.

To ensure that the thermal expansion behavior of the piston is even, several compensation volumes and/or several removal volumes are arranged symmetrically to the axis of movement.

In one embodiment, the piston has a diameter defined by an average value of the circumferential surface. A center radius and any number of radii through the axis of movement and arranged radially to the circumferential surface produce radii that preferably vary from the average radius less than 1%, more preferably less than 0.58, and even more preferably less than 1%.

The result is a piston with a particularly high degree of roundness, whereby this roundness is defined, for example, by corresponding radii. By designing the respective cross-sectional areas to be similar or even the same size, it is no longer necessary for a piston, such as a manufactured conventional piston with piston pin, to be made oval in shape. The thermal expansions are thus taken into account in advance. Such a piston, as it can be produced according to the invention, can thus be particularly round and can therefore be produced with a simple manufacturing process, for example on a turning machine. Likewise, when also used with piston rings, such a particularly round piston seals well against the round cylinder bore, so that no additional oil losses, blow-by losses, or unintentional oil leaks occur, especially during the cold start of an engine.

A “mean value of the surface” describes, for example, a mean value from all possible measurement points of a surface or all calculated points of a surface of the circumferential area. From this definition a “mean radius” can be determined, which can, for example, be the arithmetic mean of any number of radii. This mean radius is used as a reference to other radii, which can cause corresponding local deviations in the radii and therefore deviations from the roundness of the piston.

In order to be able to manufacture the piston particularly easily and lightly while generating high strength, the piston is preferably made from aluminum, such as a cast aluminum alloy, steel, or a steel alloy.

In a further aspect, the invention employs a crankshaft drive with a piston according to one of the previous aspects
in particular, a connecting rod with a thickening (connecting rod head) corresponding to the piston's connecting rod holder.

Such a crank mechanism can be pre-assembled and loaded into an internal combustion engine with the advantages the invention provides.

In a further aspect, the problem is solved by a reciprocating piston internal combustion engine with a piston according to one of the embodiments described above and/or with a crank drive as described above.

Such a reciprocating piston internal combustion engine has all the advantages of the invention, for example, a piston according to the invention can be used to improve the corresponding tolerances between piston and cylinder bore, so that wear, oil consumption during cold start, and emissions can be improved This applies in particular in connection with a piston with a connecting rod connected to the piston via the connecting rod holder.

The invention is explained in more detail below with reference to exemplary embodiments.

### BRIEF DESCRIPTION OF THE SEVERAL VIEWS OF THE DRAWINGS

FIG. 1 is a perspective view including hidden lines, showing a crank mechanism including a piston and a connecting rod.

FIG. 2a is a side elevation view of the piston from the assembly of FIG. 1.

FIG. 2b is a bottom view showing the piston from the assembly of FIG. 1.

FIG. 2c is a side elevation sectional view showing the piston from the assembly of FIG. 1.

FIG. 2d is a bottom view showing the piston from the assembly of FIG. 1, with section plane callouts.

FIG. 3a is a side elevation view, showing the connecting rod from the assembly of FIG. 1.

FIG. 3b is a perspective view, showing the connecting rod from the assembly of FIG. 1.

FIG. 4 is a side elevation view with partially shown sections, showing an embodiment of a crank drive made according to the present invention.

FIG. 5 is a perspective view with a partial cutaway, showing an internal combustion engine using crank assemblies as provided in the present invention.

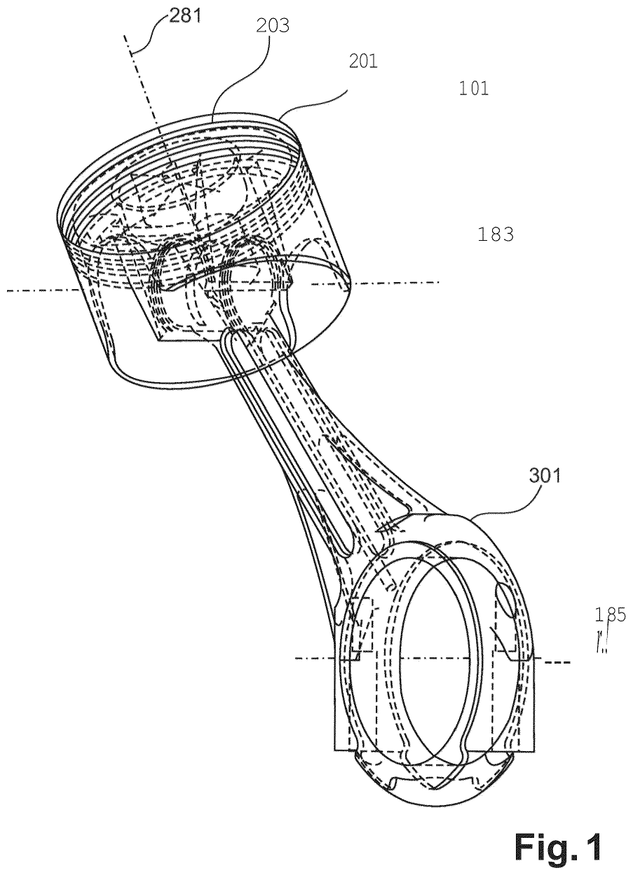

### DETAILED DESCRIPTION OF THE INVENTION

A crank unit 101 has a piston 201 and a connecting rod 301. The crank unit 101 is part of a diesel engine (not shown), whereby the corresponding diesel engine, for example, can have four, six or even eight of these crank units, whereby the respective pistons 201 are accommodated movably along a movement axis 281 within corresponding cylinders. The connecting rod 301 can be moved about a crank axis 185 on respective crankpins of a crankshaft corresponding to the cylinder number. The diesel engine is designed, for example, as an in-line four-cylinder, in-line six-cylinder or V-eight engine. In each case, it is a diesel engine with a high-pressure injection system for diesel fuel and a turbo and/or supercharging, resulting in high combustion temperatures in the respective cylinders. Of course, other designs can also be realized using the crank unit 101. The piston 201 in this example is made of an aluminum alloy.

The respective connecting rod 301 is forged from steel. The connecting rod is pivotally connected to piston 201 about a swivel axis 183, so that when the crankshaft is fully rotated (not shown) the crank axis 185 is guides through a circular motion, and the piston 201 is moved up and down in the cylinder by means of the connecting rod 301. A complete rotation of the crankshaft is thereby performed without mechanical obstacles. On an upper side 203 of the piston 201 the gas pressure generated by the combustion of injected diesel, for example, drives the piston 201 so that the engine is operated according to the diesel principle. The ignition of the injected diesel fuel is achieved through the compression of intake air in the cylinder. The compression temperature of the intake air reaches over 700° C. and the resulting combustion temperature is over 1,200° C. The thermal influences on piston 201 are correspondingly high.

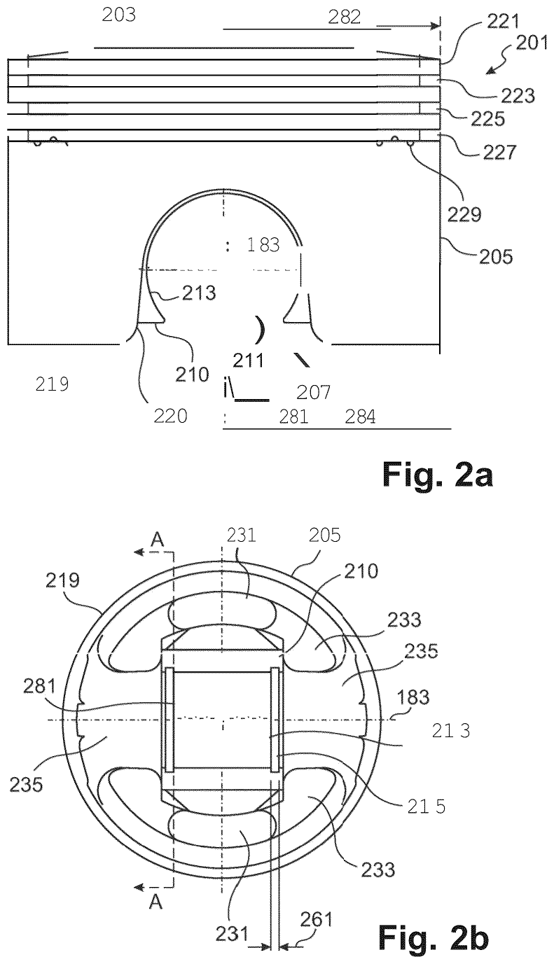

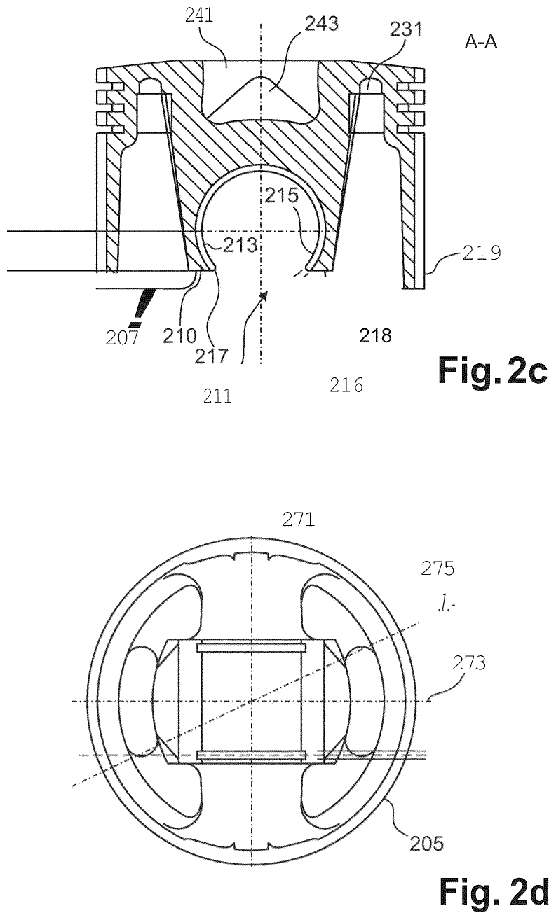

In addition to the upper side (crown) 203 directed towards the combustion chamber in the cylinder, the piston 201 has a circumferential surface 205 and a lower surface 207 (see FIG. 2a). A combustion cavity 241 with a cone-shaped dome 243 (see FIG. 2c) is arranged concentrically to the axis of movement 281 within the upper side. The cone-shaped dome 243 expands the surface area within the combustion cavity 241.

A predominant component of the circumferential surface 205 forms a piston skirt 219 (see FIG. 2c), which descends in the direction of the underside 207. The piston skirt is cylindrical and has thin walls. Starting from the upper side 203, the piston 201 has a narrow circumferential collar 221, which forms a distance from the upper side 203 to a first annular ring groove 223. A piston ring for sealing against the cylinder is arranged within this first annular groove 223. Further in the direction of the underside 207, a second annular ring groove 225 and third annular ring groove 227 are arranged, whereby in the annular groove 225 a piston ring is inserted as a sealing ring, in the annular groove 227 a piston ring in the function of an oil scraper ring (piston rings not shown in each case). Additional bores 229 are arranged on the annular groove 227, which promote the drainage of engine oil.

The circumferential collar 221 is known in the prior art in diesel engines as a so-called “firewall” and in these engines is designed in the prior art with a significantly smaller diameter than the circumferential surface 20 of a piston. However, the circumferential collar 221 in the inventive embodiment of FIG. 2a has a radius 282, this radius 282 being identical to a radius 284 of the circumferential surface 205 within technical tolerances. The piston 201 can thus be machined with respect to its cylindrical shape in a single clamping operation and in a single turning operation on a lathe to a uniform diameter.

The circumferential collar 221 can be designed in this form because the present invention provides additional cooling in order to limit thermal expansion. Collar 221 must be made as a reduced diameter in the prior art to account for increased piston crown heating that causes this area to expand significantly. The heat dissipation in the inventive piston eliminates the need for this.

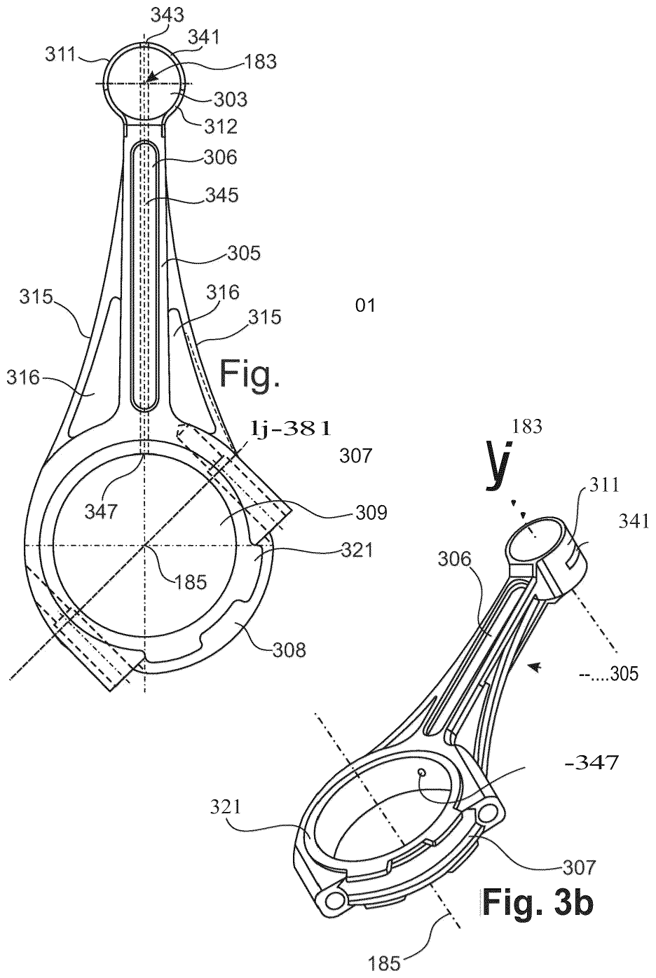

On the underside 207, the piston 201 has a connecting rod holder 210 for engaging the connecting rod 301. The holder 210 is included essentially through an undercut 211 (see FIG. 2c) formed, which is concentric around the swivel axis 183 and is characterized by a respective edge 217 at the limit of the material. In order to keep the undercut 211 accessible along the pivot axis 183 and to enable the undercut 211 to be finished with the inner surface 213 of the connecting rod holder, the piston skirt 219 has a cut-out 220 on both sides along the pivot axis 183. This cut-out 220 allows the connecting rod head 303 (see FIG. 3a) to slide laterally into the connecting rod holder and pivotally engage inner surface 213 (see FIG. 2a). In addition, the presence of cut-outs 220 allows the insertion of a tool for fine machining of the inner surface 213.

As can be seen from the underside of the piston 201 (see also FIG. 2b), the piston 201 is not radially symmetric. In addition to the directly technical volumes of the piston 201, namely the volume for forming the connecting rod holder 210 with the undercut 211, the volume for the piston skirt 219 as well as corresponding volumes for other features vary. Piston 201 has areas of thickening 231, 235. The piston also includes numerous pockets 233. The thickenings and pockets are arranged symmetrically to the swivel axis 183. The corresponding volumes of the thickenings 231, the pockets 233 and the thickenings 235 are selected in such a way that both the pockets 233 and the thickenings 235 can be the intersecting surfaces through the axis of movement 281, i.e. for example, such cut surfaces formed along a cutting plane 271, a cutting plane 273 or a cutting plane 275 (see also FIG. 2d), each with the same cross-sectional area within a tolerance of, for example, 2% in relation to the cutting plane 271 to, for example, the smallest of the respective comparative intersecting surfaces. This geometric design ensures that the thermal expansion behavior of the piston 201 is almost identical or even identical in different polar positions around the axis of movement 281. For this purpose, material is added to the thickenings 231 and material is subtracted from the pockets 233 and material is applied to the thickenings 235. In this way, for example, technically required volumes, such as for the pick-up 210, applied in the respective cutting planes are accordingly balanced. Likewise, for example, a respective thickening 235 is provided to at least partially offset the loss of cross-sectional area over the area at the cut-out 220 and missing material in the piston skirt 219. Correspondingly, other components are also compensated for by subtracting or adding corresponding volumes of the material of the piston 201 to keep the piston balanced.

Within the inner surface 213 of the undercut 211, annular retaining ring grooves 215 are provided on both sides along the pivot axis 183 (see FIG. 2b) symmetrically to the axis of movement 281, wherein these annular grooves are formed as partial annular grooves 215 due to the shape of the undercut 211. The respective annular retaining ring groove 215 has a cross-section extending from a diameter 216 of the inner surface 213 up to a diameter 218 of the inner surface 213 (see FIG. 2c).

The connecting rod 301 (see FIG. 3a) has a connecting rod head 303, a middle region 305 and a crankshaft connection 307. The connecting rod head is designed as a bulge with a cylindrical outer surface 311. The outer surface 311 is a machined to be a close sliding and pivoting fit within inner surface 213 of the piston. Furthermore, chamfers 312 are arranged at end regions of the head 303 in the direction of the pivot axis 183. The connecting rod head 303 can thus be inserted laterally into the piston along the pivot axis 183 so that a swivel joint is created between the connecting rod and the piston about the pivot axis 183.

The middle region 305 connects the connecting rod head 303 with the crankshaft connection 307 and has a central neutral plane between the connecting rod head 303 and the crankshaft connection 307. Middle region 305 also has a recess 306 on both sides, so that overall, a rigid cross-section of the middle region 305 is formed as a double T-beam. In addition, webs 315 with recesses 316 formed opposite the middle region 305 are arranged in such a way that the middle region and the crankshaft connection 307 are rigid and yet as light as possible.

Approximately half of the crankshaft connection 307 consists of a part of the connecting rod 301. The other half consists of connecting rod cap 308, with the two components being arranged concentrically around the crankshaft axis 185. In order to produce a low-friction, wear-resistant and emergency-running connection to the crankshaft, a bearing shell 321 is provided on the inner surfaces of the crankshaft eye 309. The bearing shell is provided with features that rotationally fix its position in relation to the connecting rod 301 and rod cap 308.

In addition, the connecting rod 301 has a smaller diameter valve groove 341 on the outer surface area 311 of the connecting rod head 303 (see FIG. 3b). Valve groove 341 is connected to an outlet opening 343 (see FIG. 3a). The outlet opening 343 is part of an oil channel 345, which is located between the outlet opening 343 and an inlet opening 347 arranged inside the crankshaft eye 309. The oil channel 345 is located along the neutral plane of the middle region 305 (the plane where the metal grains are neither in compression nor in tension in normal operation), so that middle region 305 is weakened as little as possible by oil. channel 345, in particular against bending.

To fit the connecting rod 301 with the piston 201, the connecting rod head 303 is pushed laterally into the piston's undercut 211 (see FIG. 2a) along the pivot axis 183. Within the annular retaining ring groove 215, an elastic retaining ring with a round wire cross-section is inserted in such a way that part of the retaining ring (not shown) is inserted into the cross-section of the undercut 211 formed by the inner surface 213. This retaining ring is then pushed back into the annular groove 215 by means of the chamfer 312 on the connecting rod head 303, whereby the cross-section of the retaining ring is selected in this way, that it can be positioned completely between the diameter 216 and the diameter 218.

The chamfer 312 thus facilitates the insertion of the connecting rod head 303 into the piston 201. The use of the retaining rings in the retaining ring grooves 215 secures the connecting rod head 303 against unintentional removal from the piston along the pivot axis 183.

The function of the crank unit 101 with regard to the lubrication of the connection between connecting rod head and piston 201 in undercut 211 is explained as follows:

Inside the crankshaft, which is not shown, there is an oil channel running for lubricating the corresponding bearing points of the crankshaft. Crankshaft oil outlet holes are provided at the bearing points. The crankshaft also has corresponding outlet holes for pressurized engine oil on the crankpin journals, which accommodate the respective connecting rod 301 around the crank axis 185. The engine oil is then fed into a circumferential annular groove on the crankshaft and flows through the inlet opening 347 (see FIG. 3a) into the oil channel 345 to the outlet opening 343. With the outlet opening 343 and the valve groove 341, an oil reservoir is created in which pressurized engine oil is stored for the lubrication of the pivoting interface between cylindrical surface 311 (on the connecting rod) and cylindrical inner surface 213 (on the piston).

Furthermore, the valve groove 341 is used to control the oil flow depending on a position of the crankshaft and a resulting position of the connecting rod 301 with respect to the piston 201. When the piston 201 has reached top dead center or bottom dead center, the connecting rod 301 is essentially vertical within the cylinder bore along the axis of movement 281. In that state, the valve groove 341 is completely sealed against the inner surface 213 of the undercut 211 so that no oil can escape through the valve groove 341. At this moment, for example when ignition of the fuel in the cylinder takes place, reliable lubrication and ideal lubrication are ensured and heat transfer between piston 201 and connecting rod 301 is ensured. Likewise, the oil cushion in the oil reservoir also prevents direct material contact.

On the power stroke the piston 201 is heated by the combustion gases and pushed downward. The crankshaft initially pivots from TDC by approximately 90° and the connecting rod 301 pivots with respect to the piston. The valve groove 341 is dimensioned in such a way that a part of the valve groove 341 is now released at an edge 217 of the undercut 211 (see FIG. 2c). At this moment, oil fed through the oil channel 345 under engine pressure is ejected from the open portion of valve groove 341. This oil has been heated as well and its discharge transfers heat away from the connecting rod/piston connection. In this state, the connection between the connecting rod head 303 and the undercut 211 is relatively lightly loaded, so that an escape of the engine oil can be used to advantage here, even if this means that less oil is available for lubrication.

If the crankshaft then approaches bottom dead center (180° from TDC), the undercut 211 closes the valve groove 341; at this moment, inertial forces of the crankshaft can therefore be applied. Further crankshaft rotation commences the exhaust stroke, and this is commenced with full oil pressure contained within the closed valve groove 341. At this point, there is also a further transfer of heat into the engine oil; at a crankshaft position of 270°, the oil pressure is then used to transfer heat out of the engine oil again as the valve groove 341 of the valve is opened by a portion of the valve groove 341 pivoting past edge 217. Up to a crankshaft position of 360° (full angle, corresponds to 0° or TDC), the valve groove 341 is then closed again by means of the edge 217, so that full oil pressure is again present in the connection at top dead center and the availability of renewed heat transfer to the oil dissipation is reached. This cycle is of course repeated with every revolution of the crankshaft, so that the result is sufficient lubrication of the movement around the pivot axis 183 as well as optimized heat dissipation from the connecting rod 301 and the piston 201.

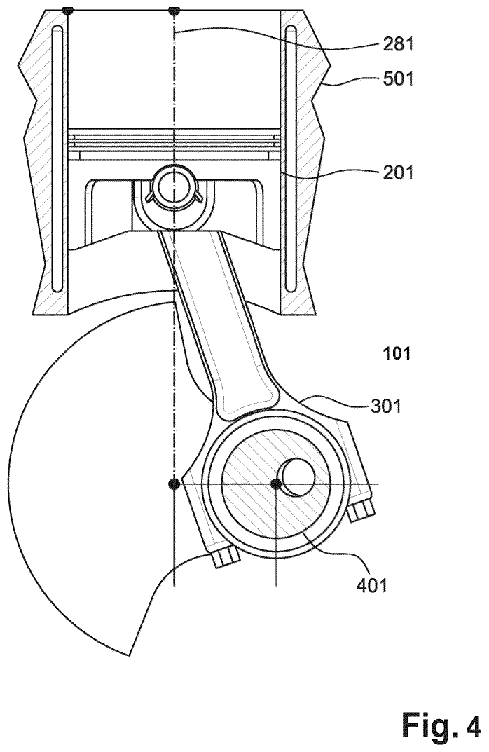

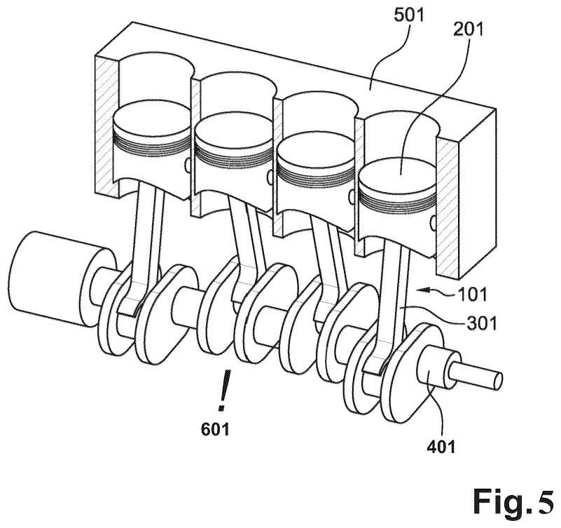

FIG. 4 shows a side view, partially sectioned, of an embodiment example of a crank mechanism according to the invention, wherein the crank mechanism comprises a piston 201 according to one of the embodiment examples described above and a piston 201 according to one of the embodiment examples described above a corresponding connecting rod 301 with an internally located lubricant guide—i.e. a crank unit 101—and a crankshaft 401. The connecting rod 301 is coupled to the crankshaft 401 in the usual manner. The piston 201 is arranged in a cylinder arrangement 501 along a movement movable along the axis 281.

FIG. 5 shows a perspective and partially sectioned view—in a detail—of an embodiment example of a reciprocating piston combustion engine 601 with a cylinder arrangement 501 with four cylinders to form a cylinder bank of an in-line four-cylinder engine and with pistons 201 and connecting rods 301 according to one of the above embodiments. In each case, a piston 201 and a connecting rod 301 form a crank unit 101. The connecting rod 301 is coupled to a crankshaft 401.

In the design examples shown in FIGS. 4 and 5, the “inner workings” of the piston 201 and the connecting rod 301 are not shown for the sake of clarity.

In this context, it should be noted that in all embodiments, the geometric design of the piston 201 also optimizes heat dissipation, as explained above. The central connection of the connecting rod 301 in the receptacle 210 of the piston 201 enables good heat conduction, so that the “fire bar” known from the prior art can also be dispensed with. Together with the simple geometry and uniform roundness of the piston 201, this makes it possible to produce a diesel engine that is easy to manufacture and also very efficient.

As a result, the diesel engine can be operated with high combustion temperatures and thus reduced emissions and efficient combustion, as the geometry of the piston 201, the compact design and the centralized combustion chambers allow the engine to be operated at high combustion temperatures. The extra heat is dissipated into the connecting rod 301 and by means of the controlled oil flow throughout the rest of the engine. The circulating oil provides good thermal management. Overall, the combination of piston 201 and connecting rod 301 according to the invention thus reduced reciprocating masses. It should be noted that although this type of piston 201 and connecting rod 301 was shown in the present example for a diesel engine with high-pressure injection and a turbocharger, the same arrangement is suitable for other types of engines and machines-including gasoline engines and compressors.

### REFERENCE NUMERALS IN THE DRAWINGS

101 Crank unit
183 Swivel axis
185 Crank axis (crank pin axis)
201 Piston
203 Top side (piston crown)
205 Circumferential surface
207 Underside (lower surface)
210 Connecting rod holder
211 Undercut
213 Inner surface
215 Retaining ring groove
216 Diameter
217 Edge
218 Diameter
219 Piston skirt
220 Cut-out
221 Perimeter collar (circumferential collar)
223 Ring groove (top compression ring groove)
225 Ring groove (second compression ring groove)
227 Ring groove (oil control ring groove)
229 Drill hole
231 Thickening
233 Pocket
235 Thickening
241 Combustion cavity
243 Cone-shaped dome
261 Width
271 Cutting plane
273 Cutting plane
275 Cutting plane
281 Axis of movement
282 Radius
284 Radius
301 Connecting rod
303 Connecting rod head
305 Middle range
306 Deepening (recess)
307 Crankshaft connection
308 Connecting rod cap
309 Crankshaft eye
311 Outer surface
312 Chamfer
315 Bar (web)
316 Recess
321 Bearing shell
341 Valve groove
343 Outlet opening
345 Oil channel
347 Entrance opening
401 Crankshaft
501 Cylinder arrangement
601 Reciprocating internal combustion engine

1. A piston (201), in particular for an engine, having an upper side (203), a lower side (207), a circumferential surface (205) running along a circumference and an axis of movement (281) running essentially parallel to a tangent of the circumferential surface (205) and through the upper side (203) and through the lower side (207), the circumferential surface (205) being used to guide the piston (201) in a cylinder bore of a cylinder along the axis of movement (281), the upper side (203) being designed for absorbing compressive forces of a gas and the underside (207) having a connecting rod holder (210), wherein the connecting rod holder (210) has an undercut (211) or a plurality of undercuts in a tension and a compression direction, so that the connecting rod holder (210) is configured to receive a head portion (303) of a connecting rod (301) which corresponds to the connecting rod holder (210) in a form-locking manner and wherein the piston can pivot relative to the connecting rod head portion about a pivot axis (183), the piston (201) having any number of substantially flat cross-sectional surfaces (271, 273, 275) arranged radially through the axis of movement (281), substantially planar cross-sectional surfaces (271, 273, 275) extending radially through the axis of movement (281), characterized in that the piston (201) is shaped in such a way that a radially arranged substantially planar first cross-sectional surface (271, 273, 275) extending through the axis of movement (281) and a radially arranged substantially planar second cross-sectional surface (271, 273, 275) extending through the axis of movement (281) have a cross-sectional area differing from one another by less than 10%.

2. The piston according to claim 1, characterized in that the piston (201) is shaped in such a way that a radially arranged substantially planar first cross-sectional surface (271, 273, 275) extending through the axis of movement (281) and a substantially planar second cross-sectional area (271, 273, 275) arranged radially through the axis of movement (281) have a cross-sectional area differing from one another by preferably less than 7%, more preferably by less than 5% and even more preferably by less than 2%.

3. The piston according to claim 1, characterized in that, on the circumferential surface (205), a piston skirt (219) extending from the upper side (203) to the underside (207), wherein the piston skirt (219) in particular has a radial thickness of preferably less than 10% of a radius (284) of the piston, more preferably less than 5% of a radius (284) of the piston, and even more preferably less than 2% of a radius (284) of the piston (201).

4. The piston according to claim 1, characterized in that a thickening (231, 235) is provided on the upper side (203) and/or on the under side (207) and/or several thickenings (231, 235) are arranged, wherein by means of the thickenings (231, 235) and/or by means of the thickenings (231, 235) a compensation for volume sections of the piston which are recessed at the respective cross-sectional area (271, 273, 275) is achieved.

5. The piston according to claim 1, characterized in that a pocket (233) and/or a plurality of pockets (233) are recessed on the top side (203) and/or on the under side (207), wherein by means of the pocket (233) and/or by means of the pockets (233), a compensation is created for volume sections of the piston (201) arranged on the respective cross-sectional areas (271, 273, 275).

6. The piston according to claim 4, characterized in that a plurality of thickenings (231) and/or several pockets (233) are arranged symmetrically to the axis of movement (281).

7. The piston according to claim 1, characterized in that the piston (201) has a mean radius defined by a mean value of the surface of the circumferential surface and any number of further radii (284) extending through the axis of movement (281) and arranged radially to the axis of movement, and the piston (201) is shaped in such a way that a radius extending laterally from the axis of movement (281) deviates from the average radius by preferably less than 1%, more preferably less than 0.5%, and even more preferably less than 1%.

8. The piston according to claim 1, characterized in that the piston (201) comprises an aluminium, a cast aluminium alloy, a steel, a cast steel alloy and/or a metal.

9. A crank unit (101) with a piston (201) according to claim 1 and in particular a connecting rod (301) with a head region (303) corresponding to the connecting rod holder (210) of the piston (201).

10. A reciprocating piston internal combustion engine comprising a piston (201) according to claim 1 and a crank mechanism (101).
